(19) United States
(12) Patent Application Publication
(10) Pub. No.: US 2010/0090545 A1
(43) Pub. Date: Apr. 15, 2010

(54) PLANAR MOTOR WITH WEDGE SHAPED MAGNETS AND DIAGONAL MAGNETIZATION DIRECTIONS

(76) Inventors: Michael B. Binnard, Belmont, CA (US); Jean-Marc Gery, Playa Del Rey, CA (US)

Correspondence Address: Roeder & Broder LLP, 5560 Chelsea Avenue, La Jolla, CA, 92037, US

(21) Appl. No.: 12/564,578

(22) Filed: Sep. 22, 2009

Related U.S. Application Data
(60) Provisional application No. 61/104,177, filed on Oct. 9, 2008.

(51) Int. Cl. H02K 41/03

(52) U.S. Cl. 310/12.05

(57) ABSTRACT

A planar motor (32) for positioning a stage (44) along a first axis, and along a second axis that is perpendicular to the first axis includes a conductor array (52) and a magnet array (34). The conductor array (52) includes at least one conductor (256). The magnet array (34) is positioned near the conductor array (52) and is spaced apart from the conductor array (52) along a third axis that is perpendicular to the first axis and the second axis. The magnet array (34) includes a first magnet unit (264) having a first diagonal magnet (D1) with a diagonal magnetization direction (268) that is diagonal to the first axis, the second axis and the third axis. This leads to strong magnetic fields above the magnet array (34) and strong force generation capability. Further, the planar motor (32) provided herein has less stray magnetic fields that extend beyond the magnet array (34) than a comparable prior art planar motor. Moreover, the first magnet unit (264) can include a second diagonal magnet (D2), a third diagonal magnet (D3), and a fourth diagonal magnet (D4) that cooperate to provide a first combined magnetic flux (276) that is somewhat aligned along the third axis in a first flux direction. In this embodiment, each diagonal magnet (D1) (D2) (D3) (D4) has the diagonal magnetization direction (268) that is diagonal to the first axis, the second axis and the third axis. Moreover, each diagonal magnet (D1) (D2) (D3) (D4) can be generally triangular wedge shaped and the diagonal magnets (D1) (D2) (D3) (D4) are arranged together into the shape of a parallelepiped.

### RELATED APPLICATION

This application claims priority on U.S. Provisional Application Ser. No. 61/104,177 filed on Oct. 9, 2008 and entitled “WEDGE MAGNET ARRAY FOR PLANAR MOTOR”. As far as is permitted, the contents of U.S. Provisional Application Ser. No. 61/104,177 are incorporated herein by reference.

### BACKGROUND

Exposure apparatuses for semiconductor processing are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, a measurement system, and a control system.

One type of stage assembly includes a stage base, a stage that retains the wafer or reticle, and one or more movers that move the stage and the wafer or the reticle. One type of mover is a planar motor that moves the stage along two axes and about a third axis. A common planar motor includes a magnet array having a plurality of magnets aligned in a two dimensional array, and a conductor array that includes a plurality of conductors aligned in a two dimensional array. With this design, electrical current applied to the conductor array generates an electromagnetic field that interacts with the magnetic field of the magnet arrays to generate a controlled force that can be used to move one of the arrays relative to the other array.

Unfortunately, stray magnetic fields from the magnetic array can adversely influence the accuracy of various components of the exposure apparatus, and thereby impair the quality of the images that are being transferred to the wafer. Moreover, there is a never ending search to increase the efficiency of the movers utilized in the exposure apparatus.

### SUMMARY

The present invention is directed to planar motor for positioning a stage along a first axis, and along a second axis that is perpendicular to the first axis. The planar motor includes a conductor array and a magnet array. The conductor array includes at least one conductor. The magnet array is positioned near the conductor array and is spaced apart from the conductor array along a third axis that is perpendicular to the first axis and the second axis. In one embodiment, the magnet array includes a first magnet unit having a first diagonal magnet with a diagonal magnetization direction that is diagonal to the first axis, the second axis and the third axis. This leads to strong magnetic fields above the magnet array and strong force generation capability. As a result thereof, the planar motor can move the stage and a work piece with improved efficiency. Further, the planar motor provided herein has less stray magnetic fields that extend beyond the magnet array than a comparable prior art planar motor. As a result thereof, the planar motor can be used in an exposure apparatus that manufactures higher quality wafers.

As provided herein, one of the arrays is secured to the stage, and current directed to the conductor array generates a controllable force along the first axis, along the second axis, and about the third axis.

In one embodiment, the diagonal magnetization direction is at a magnetization angle that is approximately forty-five degrees relative to each axis. Further, the first magnet unit can include a second diagonal magnet, a third diagonal magnet, and a fourth diagonal magnet that cooperate to provide a first combined magnetic flux that is somewhat aligned along the third axis in a first flux direction. In this embodiment, each diagonal magnet has a magnetization direction that is diagonal to the first axis, the second axis and the third axis. Moreover, each diagonal magnet can be generally triangular wedge shaped and the diagonal magnets are arranged together in the shape of a parallelepiped.

In certain embodiment, the first magnet unit additionally includes (i) a first transverse magnet that is positioned adjacent to the first diagonal magnet, (ii) a second transverse magnet that is positioned adjacent to the second diagonal magnet, (iii) a third transverse magnet that is positioned adjacent to the third diagonal magnet, and (iv) a fourth transverse magnet that is positioned adjacent to the fourth diagonal magnet. In these embodiments, each transverse magnet has a magnetization direction that is transverse to the third axis.

Additionally, the first magnet unit can include (i) a fifth diagonal magnet that is positioned adjacent to the first transverse magnet, (ii) a sixth diagonal magnet that is positioned adjacent to the second transverse magnet, (iii) a seventh diagonal magnet that is positioned adjacent to the third transverse magnet, and (iv) an eighth diagonal magnet that is positioned adjacent to the fourth transverse magnet.

As provided herein, the motor can also include a second magnet unit, a third magnet unit, and a fourth magnet unit, and each magnet unit is similar in design. In this embodiment, the magnet units are organized adjacent to each other in a two dimensional array along the first axis and the second axis. Further, the fifth diagonal magnet (also the sixth, seventh, and eighth diagonal magnets) of the first magnet unit cooperates with adjacent magnet units to provide a second combined magnetic flux that is somewhat aligned along the third axis in a second flux direction that is opposite to the first flux direction.

In an alternative embodiment, the first magnet unit includes a pyramid shaped magnet. In this embodiment, the diagonal magnets are arranged together with the pyramid shaped magnet into the shape of a rectangle.

Additionally, the present invention is directed to a stage assembly that moves a device. In this embodiment, the stage assembly includes a stage that retains the device, and the motor disclosed herein applies forces to move and control the position of the stage.

The present invention is also directed to an exposure apparatus including an illumination system and a stage assembly that moves the device relative to the illumination system. Further, the present invention is directed to a process for manufacturing a device (e.g. a wafer or other device) that includes the steps of providing a substrate and forming an image onto the substrate with the exposure apparatus disclosed herein.

In yet another embodiment, the present invention is directed to a method for positioning a stage along a first axis, and along a second axis that is perpendicular to the first axis. In this embodiment, the method includes the steps of (i) coupling a planar motor having the features disclosed above to the stage, and (ii) directing current to the conductor array to generate a controllable force along the first axis and along the second axis.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2A is a simplified top view and FIG. 2B is a simplified side view of a planar motor having features of the present invention;

FIG. 3A is a perspective view of a magnet unit of the planar motor of FIG. 2A;

FIG. 3B is a cutaway view taken on line 3B-3B in FIG. 3A;

FIG. 3C is a cutaway view taken on line 3C-3C in FIG. 3A;

FIG. 4 is a perspective view of a portion of a magnet array having features of the present invention;

FIG. 5 is an exploded perspective view of a portion of the magnet unit of FIG. 3A;

FIG. 6A is a perspective view of another embodiment of a portion of the magnet unit having features of the present invention;

FIG. 6B is a perspective view of the portion of the magnet unit of FIG. 6A;

FIG. 6C is a cutaway view taken on line 6C-6C in FIG. 6A;

FIG. 6D is a cutaway view taken on line 6D-6D in FIG. 6A;

FIG. 6E is a cutaway view of a portion of a magnet array;

FIG. 7A is a flow chart that outlines a process for manufacturing a device in accordance with the present invention; and

FIG. 7B is a flow chart that outlines device processing in more detail.

### DESCRIPTION

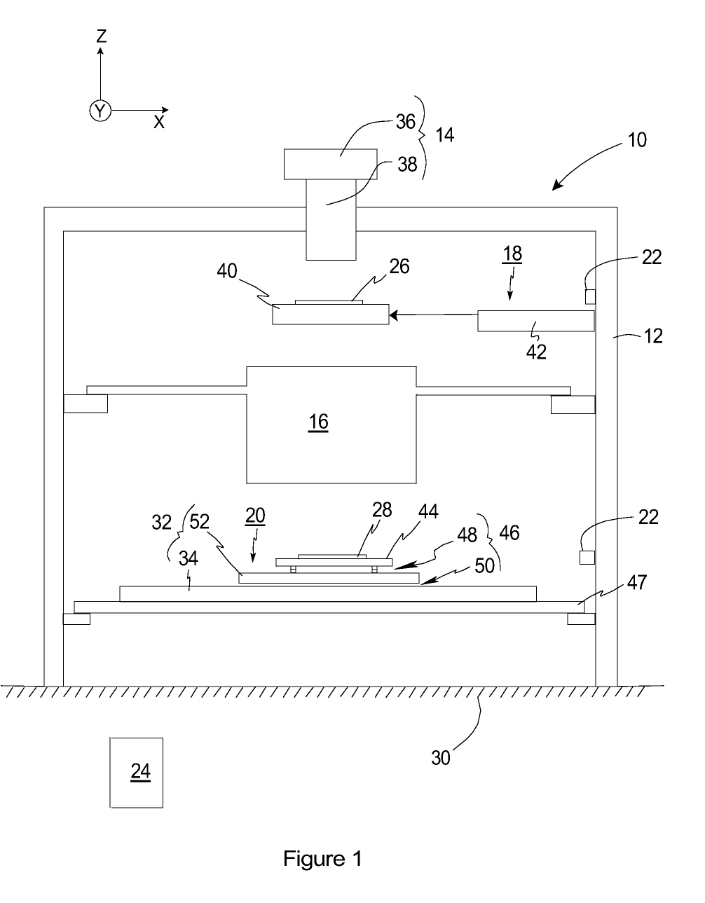

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10. The exposure apparatus 10 is particularly useful as a lithographic device that transfers a pattern (not shown) of an integrated circuit from a reticle 26 onto a semiconductor wafer 28. The exposure apparatus 10 mounts to a mounting base 30, e.g., the ground, a base, or floor or some other supporting structure.

As an overview, in certain embodiments, one or both of the stage assemblies 18, 20 are uniquely designed to move and position a work piece (e.g. the wafer 28) with improved efficiency and reduced stray magnetic fields. More specifically, in certain embodiments, one or both stage assemblies 18, 20 includes a planar motor 32 having an improved magnet array 34 that allows for the work piece to be moved and positioned with improved efficiency and reduced stray magnetic fields. As a result thereof, the exposure apparatus 10 can be used to manufacture higher quality wafers 28 with improved efficiency.

A number of Figures include an orientation system that illustrates the X axis, the Y axis that is orthogonal to the X axis, and the Z axis that is orthogonal to the X and Y axes. It should be noted that any of these axes can also be referred to as the first, second, and/or third axes.

There are a number of different types of lithographic devices. For example, the exposure apparatus 10 can be used as a scanning type photolithography system that exposes the pattern from the reticle 26 onto the wafer 28 with the reticle 26 and the wafer 28 moving synchronously. Alternatively, the exposure apparatus 10 can be a step-and-repeat type photolithography system that exposes the reticle 26 while the reticle 26 and the wafer 28 are stationary.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a reticle pattern from a reticle to a substrate with the reticle located close to the substrate without the use of a lens assembly.

The apparatus frame 12 is rigid and supports the components of the exposure apparatus 10. The apparatus frame 12 illustrated in FIG. 1 supports the reticle stage assembly 18, the optical assembly 16, the illumination system 14, and the wafer stage assembly 20 above the mounting base 30.

The illumination system 14 includes an illumination source 36 and an illumination optical assembly 38. The illumination source 36 emits a beam (irradiation) of light energy. The illumination optical assembly 38 guides the beam of light energy from the illumination source 36 to the optical assembly 16. The beam illuminates selectively different portions of the reticle 26 and exposes the wafer 28. In FIG. 1, the reticle 26 is at least partly transparent, and the beam from the illumination system 14 is transmitted through a portion of the reticle 26. Alternatively, the reticle 26 can be reflective, and the beam can be directed at the bottom of the reticle 26.

As non-exclusive examples, the illumination source 36 can be a g-line source (436 nm), an i-line source (365 nm), a KrF excimer laser (248 nm), an ArF excimer laser (193 nm), an F₂ laser (157 nm), or an EUV source (13.5 nm). Alternatively, the illumination source 36 can generate charged particle beams such as an x-ray or an electron beam.

The optical assembly 16 projects and/or focuses the light passing through the reticle 26 to the wafer 28. Depending upon the design of the exposure apparatus 10, the optical assembly 16 can magnify or reduce the image illuminated on the reticle 26. It could also be a 1× magnification system.

The reticle stage assembly 18 holds and positions the reticle 26 relative to the optical assembly 16 and the wafer 28. The reticle stage assembly 18 can include (i) a reticle stage 40 that includes a chuck for holding the reticle 26, and (ii) a reticle stage mover assembly 42 that moves and positions the reticle stage 40 and the reticle 26. For example, the reticle stage mover assembly 42 can move the reticle stage 40 and the reticle 26 along the X, Y and Z axes, and about the X, Y and Z axes (six degrees of freedom). Alternatively, for example, the reticle stage mover assembly 42 could be designed to move the reticle stage 40 and the reticle 26 with fewer than six degrees of freedom. In FIG. 1, the reticle stage mover assembly 42 is illustrated as a box. The reticle stage mover assembly 42 can be designed to include one or more planar motors having features of the present invention.

The wafer stage assembly 20 holds and positions the wafer 28 relative to the optical assembly 16 and the reticle 26. The wafer stage assembly 20 can include (i) a wafer stage 44 that includes a chuck for holding the wafer 28, (ii) a wafer stage mover assembly 46 that moves and positions the wafer stage 44 and the wafer 28, and (iii) a wafer stage base 47 that secures a portion of the wafer stage mover assembly 46 to the apparatus frame 10. For example, the wafer stage mover assembly 46 can move the wafer stage 44 and the wafer 28 along the X, Y and Z axes, and about the X, Y and Z axes. Alternatively, for example, the wafer stage mover assembly 46 could be designed to move the wafer stage 44 and the wafer 28 with fewer than six degrees of freedom.

In one embodiment, for example, the wafer stage assembly 20 can include (i) a fine mover assembly 48 that positions the wafer 28 with great accuracy with six degrees of freedom, and (i) a coarse mover assembly 50 that positions a portion of the fine mover assembly 48 with three degrees of freedom so that fine mover assembly 48 is maintained within its operational range. As provided herein, the mover assemblies 48, 50 can include one or more linear motors, rotary motors, planar motors as disclosed herein, voice coil actuators, or other type of actuators. In FIG. 1, the coarse mover assembly 50 includes the planar motor 32 that moves along the X axis, along the Y axis, and about the Z axis.

In addition to the magnet array 34, the planar motor 32 includes a conductor array 52. In FIG. 1, a portion of the fine mover assembly 48 is secured to the conductor array 50 and moves with the conductor array 50. In this embodiment, the portion of the fine mover assembly 48 that moves with the conductor array 50 can be referred to as a stage.

The measurement system 22 monitors movement of the reticle 26 and the wafer 28 relative to the optical assembly 16 or some other reference. With this information, the control system 24 can control the reticle stage assembly 18 to precisely position the reticle 26 and the wafer stage assembly 20 to precisely position the wafer 28. For example, the measurement system 22 can utilize multiple laser interferometers, encoders, and/or other measuring devices.

The control system 24 is electrically connected to the reticle stage assembly 18, the wafer stage assembly 20, and the measurement system 22. The control system 24 receives information from the measurement system 22 and controls the stage assemblies 18, 20 to precisely position the reticle 26 and the wafer 28. The control system 24 can include one or more processors and circuits.

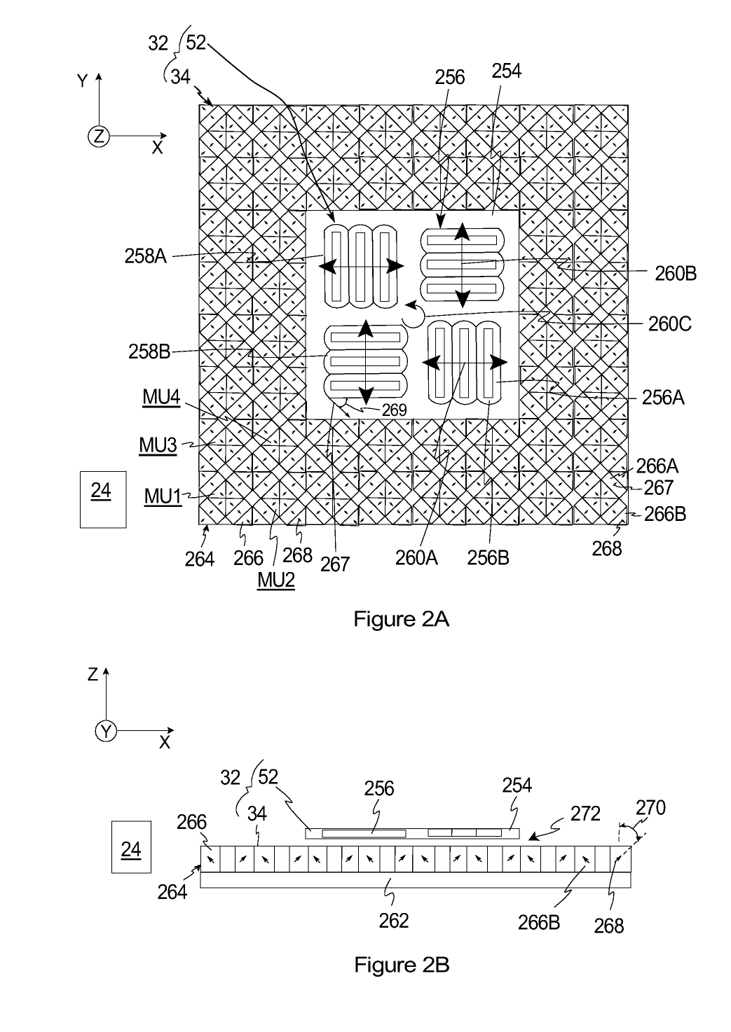

FIG. 2A is a simplified top view and FIG. 2B is a simplified side view of the planar motor 32 that is used to position a stage and/or a work piece. The control system 24 is also illustrated schematically in FIGS. 2A and 2B. As described above in reference to FIG. 1, the planar motor 32 can be used in the wafer stage assembly 20 to position the wafer 28 and the wafer stage 44. Alternatively, the planar motor 32 can be used to move other types of work pieces during manufacturing and/or inspection, to move a device under an electron microscope (not shown), or to move a device during a precision measurement operation (not shown). For example, the planar motor 32 could be used in the reticle stage assembly 18 illustrated in FIG. 1.

FIGS. 2A and 2B illustrate the conductor array 52 and the magnet array 34 of the planar motor 32 in more detail. In this embodiment, current from the control system 24 directed to the conductor array 52 generates a controllable electromagnetic force along the X axis, along the Y axis and about the Z axis that can be used to move one of the arrays relative to the other array. In FIGS. 2A and 2B, the conductor array 52 moves relative to the magnet array 34. Alternatively, the motor 32 can be designed so that the magnet array 34 moves relative to the conductor array 52. The design, size and shape of each array 34, 52 and the components can be varied to achieve the movement requirements of the planar motor 32.

In one embodiment, the conductor array 52 includes a conductor housing 254 and a plurality of conductors 256 (not shown in FIG. 2B). The conductor housing 254 is rigid and retains the conductors 256. In FIGS. 2A and 2B, the conductor housing 254 is generally rectangular shaped, and the conductor array 52 includes twelve racetrack shaped conductors 256 (oval coils). In this embodiment, each of the conductors 256 include a pair of spaced apart, generally straight, coil legs 256A, and a pair of spaced apart arc shaped end turns 256B that connect the coil legs 256A together. Further, the conductors 256 are arranged two dimensionally along the X axis and along the Y axis. Alternatively, the conductor housing 254 can have a shape different than that illustrated in these Figures, the conductor array 52 can include more than twelve or less than twelve conductors 256, and/or the conductors 256 can have a shape other than oval.

In one, non-exclusive embodiment, the conductors 256 are organized into a plurality of X conductor groups 258A, and a plurality of Y conductor groups 258B. In this embodiment, (i) the conductors 256 of the X conductor groups 258A are positioned side by side along the X axis with the coil legs 256A aligned and extending along the Y axis, and (ii) the conductors 256 of the Y conductor groups 258B are positioned side by side along the Y axis with the coil legs 256A aligned and extending along the X axis. With this design, (i) the control system 24 directs current to one or more of the conductors 256 of X conductor groups 258A to generate a controllable X force 260A along the X axis, and (ii) the control system 24 directs current to one or more of the conductors 256 of the Y conductor groups 258B to generate a controllable Y force 260B along the Y axis. Further, the control system 24 can direct current to the conductors 256 of either or both of the conductor groups 258A, 258B to generate a controllable theta Z moment 260C about the Z axis. Stated in another fashion, electrical current through the conductors 256 causes the conductors 256 to interact with the magnetic field of the magnet array 34 to generate a Lorentz type force that can be used to control, move, and position one of the arrays 34, 52 relative to the other array 34, 52 along the X and Y axes, and about the Z axis. The current level for each conductor 256 is individually controlled and adjusted by the control system 24 to achieve the desired resultant forces.

The number of conductor groups 258A, 258B and the number of conductors 256 in each group can be varied to suit the movement requirements of the motor 32. In FIG. 2A, the conductor array 52 includes two X conductor groups 258A, and two Y conductor groups 258B. Further, each of the conductor groups 258A-258D includes three conductors 256. With this design, the planar motor 32 can be operated as four individual three phase motors.

The magnet array 34 includes a magnet housing 262 and a plurality of similar magnet units 264. The magnet housing 262 is rigid and retains the magnet units 264. In one embodiment, the magnet housing 262 is generally rectangular shaped, and the magnet array 34 includes sixty-four, somewhat rectangular shaped magnet units 264. In FIG. 2A, for reference, (i) a first magnet unit is labeled MU1, (ii) a second magnet unit is labeled MU2; (iii) a third magnet unit is labeled MU3, and (iv) a fourth magnet unit is labeled MU4. In this embodiment, the magnet units 264 are arranged two dimensionally (like a checkerboard) along the X axis and along the Y axis. Alternatively, the magnet housing 262 can have a shape different than that illustrated in these Figures, the magnet array 34 can include more than sixty-four or less than sixty-four magnet units 264, and/or each of the magnet units 264 can have a shape different than rectangular.

The magnet housing 262 can optionally be made of a highly magnetically permeable material, such as a soft iron that provides some shielding of the magnetic fields, as well as providing a low reluctance magnetic flux return path for the magnetic fields of the magnet units 264.

In certain embodiments, as described in more detail below, each magnet unit 264 includes a plurality of magnets 266 and each of the magnets 266 has its own magnetization direction. More specifically, in certain embodiments, each magnet unit 264 can include (i) one or more transverse magnets 266A and each transverse magnet 266A has a transverse magnetization direction 267, and (ii) one or more diagonal magnets 266B and each diagonal magnet 266B has a diagonal magnetization direction 268. In FIG. 2A, the magnet units 264 are designed and positioned so that the magnetization direction 267, 268 of each magnet 266 is angled relative to a longitudinal axis of the coil legs 256A of the conductors 256, and the X, Y, and Z axes.

In one non-exclusive embodiment, for example, each transverse magnetization direction 267 can be at approximately a forty-five degree transverse magnetization angle 269 relative to a longitudinal axis of the coil legs 256A of the conductors 256, and the X, and Y axes. In FIG. 2A, one of the transverse magnetization directions 267 is illustrated near one of the conductors 256 for reference. Moreover, the transverse magnetization direction 267 is at a ninety degree angle relative to the Z axis.

Further, in one non-exclusive embodiment, each diagonal magnetization direction 268 can be at approximately a forty-five degree diagonal magnetization angle 270 relative to the Z axis.

Additionally, the planar motor 32 can include a fluid bearing assembly (not shown) that creates a fluid type bearing (not shown) between conductor array 52 and the magnet array 34. The fluid type bearing maintains the arrays 34, 52 adjacent to each other and spaced apart along the Z axis an array gap 272, and allows for relative movement between these components along the X axis, along the Y axis and about the Z axis. The fluid type bearing can be a vacuum preload type fluid bearing. Alternatively, another type of bearing can be utilized. For example, an electromagnetic type bearing can be utilized, or the planar motor can provide forces and moments to control all six degrees of freedom.

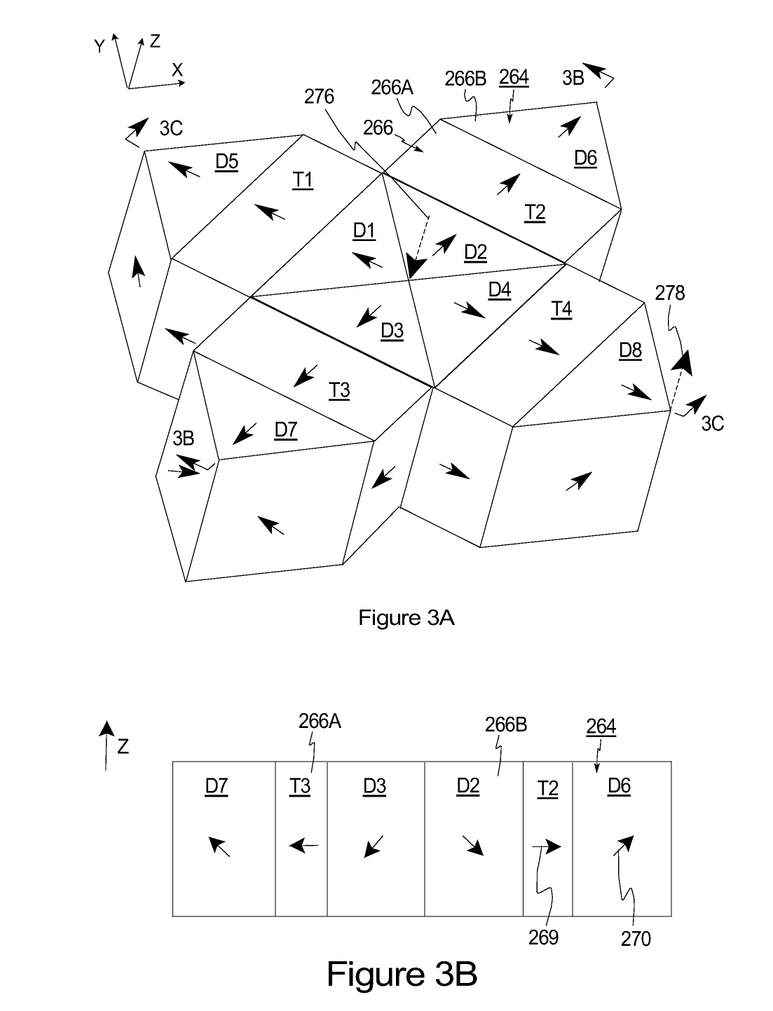

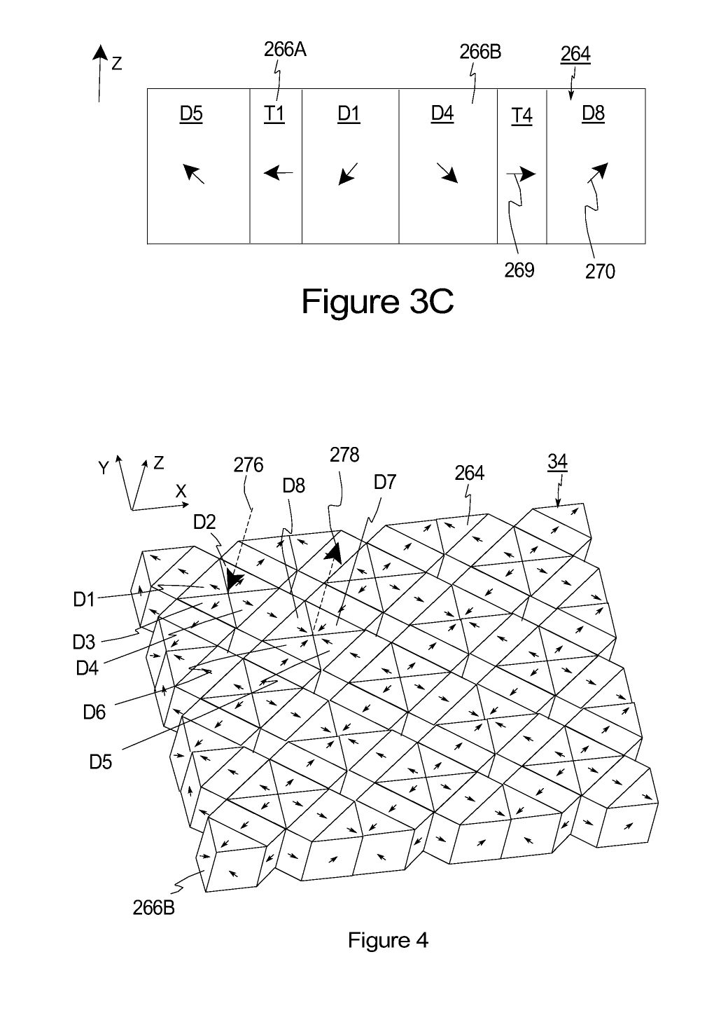

FIG. 3A is a perspective view of one embodiment of one of the magnet units 264 of FIG. 2A. In this embodiment, the magnet unit 264 defines a single pitch of the magnet array 34 (illustrated in FIG. 2A). As described above, in one embodiment, each magnet unit 264 includes the plurality of magnets 266 and each of the magnets 266 has its own magnetization direction (“magnetic orientation”) that is illustrated as an arrow. Further, the magnetization direction of each adjacent magnet 266 is different.

In one embodiment, each magnet unit 264 is generally rectangular shaped and is built out of a combination of (i) the transverse magnets 266A that have the transverse magnetization direction 269 that is transverse (horizontal) and substantially perpendicular to the vertically oriented Z axis, and (ii) the diagonal magnets 266B that have the diagonal magnetization direction 268 that is at an approximately forty-five degree angle relative to the vertical Z axis. With this design, none of the magnets 266A, 266B of the magnet unit 264 illustrated in FIG. 3A are oriented along the Z axis.

In one embodiment, each of the transverse magnets 266A is generally rectangular block shaped and each of the diagonal magnets 266B is generally triangular prismatic (wedge) shaped. Further, the transverse magnets 266A are sometimes referred to herein as rectangular magnets, and the diagonal magnets 266B are sometimes referred to herein as triangular magnets. Each of the magnets 266A, 266B can be made of a high energy product, rare earth, permanent magnetic material such as NdFeB. Alternatively, for example, one or more of the magnets 266A, 266B can be made of a low energy product, ceramic or other type of material that is surrounded by a magnetic field.

The number and arrangement of the magnets 266 in each magnet unit 264 can be varied. In one embodiment, each magnet unit 264 includes eight diagonal magnets 266B, and four transverse magnets 266A. Stated in another fashion, there are four rectangular block shaped transverse magnets 266A which are magnetized in the NE, SE, NW, and SW horizontal directions, and there are also eight triangular prism shaped diagonal magnets 266B which are magnetized in a direction that is tilted 45° up or down from the NE, SE, NW, and SW direction. In this embodiment, (i) four of the diagonal magnets 266B that are labeled D1, D2, D3, D4 are arranged together to form a square that is at a center of the magnet unit 264; (ii) the transverse magnet 266A labeled T1 is secured to and positioned against the diagonal magnet labeled D1; (iii) the transverse magnet 266A labeled T2 is secured to and positioned against the diagonal magnet labeled D2; (iv) the transverse magnet 266A labeled T3 is secured to and positioned against the diagonal magnet labeled D3; (v) the transverse magnet 266A labeled T4 is secured to and positioned against the diagonal magnet labeled D4; (vi) the diagonal magnet labeled D5 is secured to and positioned against the transverse magnet 266A labeled T1; (vii) the diagonal magnet labeled D6 is secured to and positioned against the transverse magnet 266A labeled T2; (viii) the diagonal magnet labeled D7 is secured to and positioned against the transverse magnet 266A labeled T3; and (ix) the diagonal magnet labeled D8 is secured to and positioned against the transverse magnet 266A labeled T4.

It should be noted that any of the transverse magnets 266A can be referred to herein as a first, second, third or fourth transverse magnet, and any of the diagonal magnets 266B can be referred to herein as a first, second, third, fourth, fifth, sixth, seventh, or eighth transverse magnet.

In this embodiment, the four diagonal magnets 266B labeled D1-D4 cooperate to provide a first combined magnetic field 276 (illustrated with a dashed arrow) that is directed in a first flux direction (e.g. generally downward in FIG. 3B) along the Z axis. Further, when the magnet units 264 are assembled in the magnet array 34 (as illustrated in FIG. 2A), the four diagonal magnets 266B in the corners labeled D5-D8 will cooperate with the diagonal magnets 266B in adjacent magnet units 264 to provide a second combined magnetic field 278 (illustrated with a dashed arrow) that is directed in a second flux direction (e.g. generally directed upward in FIG. 3A) along the Z axis. With this design the assembled magnet array 34 has poles that alternate between generally North along the Z axis, transversely oriented to the Z axis, and generally South along the Z axis. This leads to strong magnetic fields above the magnet array 34 and strong force generation capability. Further, the diagonal magnets 266B with the diagonal magnetization directions 266B which are not horizontal or vertical can offer substantial performance improvements in planar motors. More specifically, better performance is achieved because there are four diagonal magnets 266B that cooperate to push the magnetic flux either in the North direction or the South direction. With the present design, there is a better force constant for the same volume of magnet material compared to the prior art.

It should be noted that the magnet unit 264 can be designed so that the flux lines are the opposite of those illustrated in FIG. 3A. In this example, (i) the four diagonal magnets 266B labeled D1-D4 in the middle cooperate to provide a first combined magnetic field that is generally upward along the Z axis, and (ii) the four diagonal magnets 266B in the corners labeled D5-D8 will cooperate with the diagonal magnets 266B in adjacent magnet units 264 to provide a second combined magnetic field that is generally downward along the Z axis.

FIG. 3B is a cut-away view of the magnet unit 264 of FIG. 3A taken on line 3B-3B in FIG. 3A. This Figure illustrates the magnetization directions of the magnets D7, T3, D3, D2, T2, D6 in more detail. In this embodiment, (i) diagonal magnet 266B D7 has a diagonal magnetic orientation 270 of 315 degrees from the Z axis (measured clockwise as illustrated in the figure); (ii) transverse magnet 266A T3 has a transverse magnetic orientation 269 of 270 degrees from the Z axis; (iii) diagonal magnet 266B D3 has a diagonal magnetic orientation 270 of 225 degrees from the Z axis; (iv) diagonal magnet 266B D2 has a diagonal magnetic orientation 270 of 135 degrees from the Z axis; (v) transverse magnet 266A T2 has a transverse magnetic orientation 269 of 90 degrees from the Z axis; and (vi) diagonal magnet 266B D6 has a diagonal magnetic orientation 270 of 45 degrees from the Z axis.

FIG. 3C is a cut-away view of the magnet unit 264 of FIG. 3A taken on line 3C-3C in FIG. 3A. This Figure illustrates the magnetization directions of the magnets D5, T1, D1, D4, T4, D8 in more detail. In this embodiment, (i) diagonal magnet 266B D5 has a diagonal magnetic orientation 270 of 315 degrees from the Z axis (measured clockwise as illustrated in the figure); (ii) transverse magnet 266A T1 has a transverse magnetic orientation 269 of 270 degrees from the Z axis; (iii) diagonal magnet 266B D1 has a diagonal magnetic orientation 270 of 225 degrees from the Z axis; (iv) diagonal magnet 266B D4 has a diagonal magnetic orientation 270 of 135 degrees from the Z axis; (v) transverse magnet 266A T4 has a transverse magnetic orientation 269 of 90 degrees from the Z axis; and (vi) diagonal magnet 266B D8 has a diagonal magnetic orientation 270 of 45 degrees from the Z axis.

FIG. 4 is a perspective view of a portion of a magnet array 34 that includes nine magnet units 264 that are positioned in a two dimensional array. As provided herein, the assembled magnet array 34 has poles that alternate in the pattern of a checkerboard oriented 45° from the X and Y axes between generally North along the Z axis and generally South along the Z axis. FIG. 4 illustrates that the four diagonal magnets 266B labeled D1-D4 cooperate to provide the first combined magnetic field 276 directed generally downward along the Z axis. Further, when the magnet units 264 are assembled in the magnet array 34, the four diagonal magnets 266B labeled D5-D8 of four adjacent magnet units 264 will cooperate to provide the second combined magnetic field 278 that is directed generally upward along the Z axis.

It should be noted that with the design of the magnet units 264 disclosed herein, there is only one diagonal magnet 266B at each corner, and two diagonal magnets 266B at each pole location along the edges of the magnet array. This configuration reduces the stray magnetic field that extends beyond the magnet array 34.

FIG. 5 is an exploded perspective view of the diagonal magnets 266B labeled D1, D2, D3, D4. This figure illustrates that the diagonal magnets 266B are generally triangular prismatic (wedge) shaped. The arrows indicate the magnetization direction as seen on each face of the magnets.

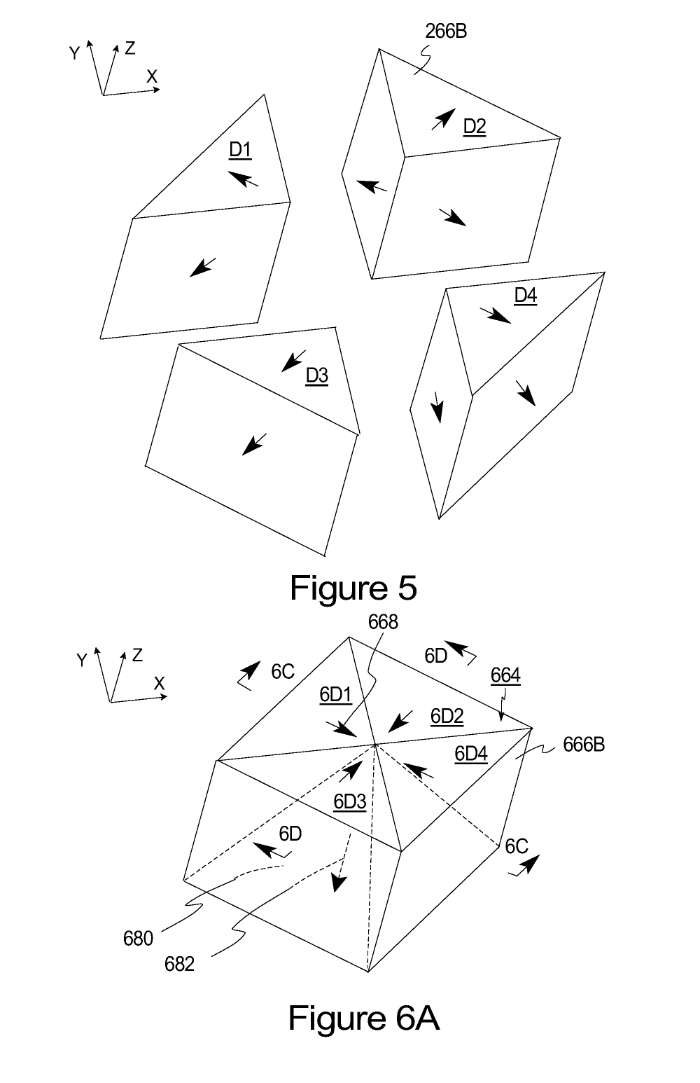

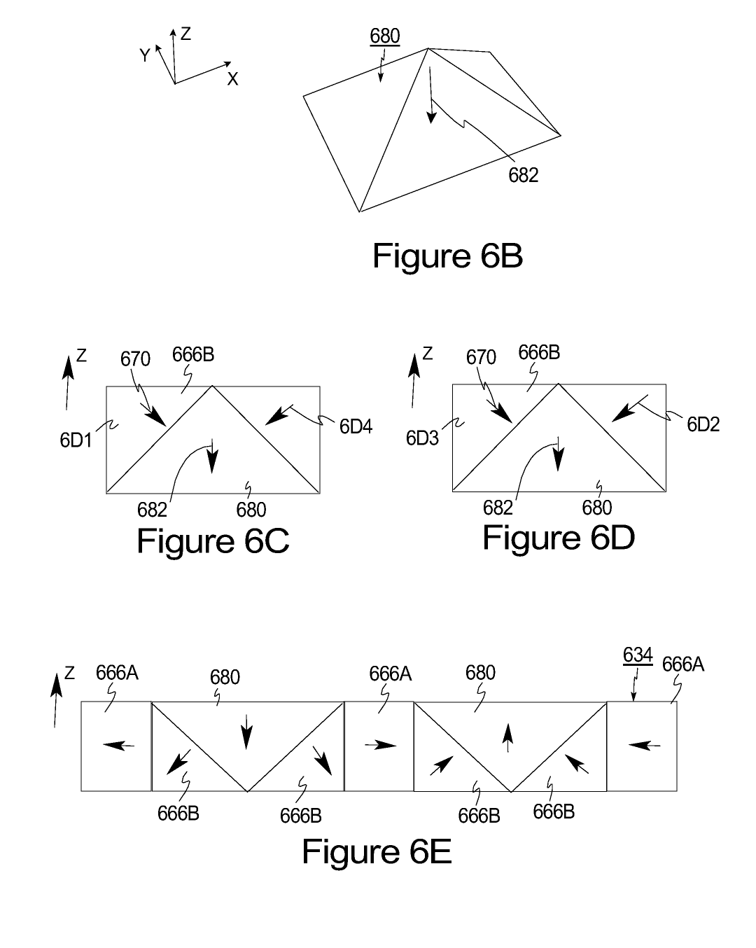

FIG. 6A is a perspective view of a portion of another embodiment of a magnet unit 664. More specifically, the portion illustrated in FIG. 6A can replace the four diagonal magnets 266B labeled D1, D2, D3, D4 in FIG. 5. In this embodiment, the magnet unit 664 includes (i) four diagonal magnets 666B labeled 6D1, 6D2, 6D3, 6D4 that each has a diagonal magnetization direction 668 that is at a 45 degree angle relative to the Z axis, the X axis, and the Y axis and (ii) a pyramid shaped magnet 680 (illustrated in phantom) that has a pyramid magnetization direction 682 that is parallel to the Z axis. In this embodiment, the four diagonal magnets 666B and the pyramid magnet 680 are assembled into the shape of a square.

FIG. 6B is a perspective view of the pyramid magnet 680. In this embodiment, the sides are triangular and converge at a point. In this embodiment, the base of the pyramid is square. Alternatively, the base can have another configuration. FIG. 6B also illustrates the pyramid magnetization direction 682 is downward along the Z axis.

FIG. 6C is a cutaway view taken on line 6C-6C in FIG. 6A. In this embodiment, (i) diagonal magnet 666B 6D1 has a diagonal magnetic orientation 670 of approximately 135 degrees from the Z axis (measured clockwise as illustrated in the figure); (ii) pyramid magnet 680 has a pyramid magnetic orientation 682 of 180 degrees from the Z axis; and (iii) diagonal magnet 666B 6D4 has a diagonal magnetic orientation 670 of approximately 225 degrees from the Z axis.

FIG. 6D is a cutaway view taken on line 6D-6D in FIG. 6A. In this embodiment, (i) diagonal magnet 666B 6D3 has a diagonal magnetic orientation 670 of approximately 135 degrees from the Z axis (measured clockwise as illustrated in the figure); (ii) pyramid magnet 680 has a pyramid magnetic orientation 682 of 180 degrees from the Z axis; and (iii) diagonal magnet 666B 6D2 has a diagonal magnetic orientation 670 of approximately 225 degrees from the Z axis.

FIG. 6E is a cutaway view of a portion of a magnet array 634 that includes the pyramid magnets 680, the diagonal magnets 666B, and the transverse magnets 666A. In the same manner as the previously described embodiment, with this design the assembled magnet array 634 has poles that alternate between generally North along the Z axis and generally South along the Z axis in a checkerboard pattern where the checkerboard is oriented 45° to the X and Y axes.

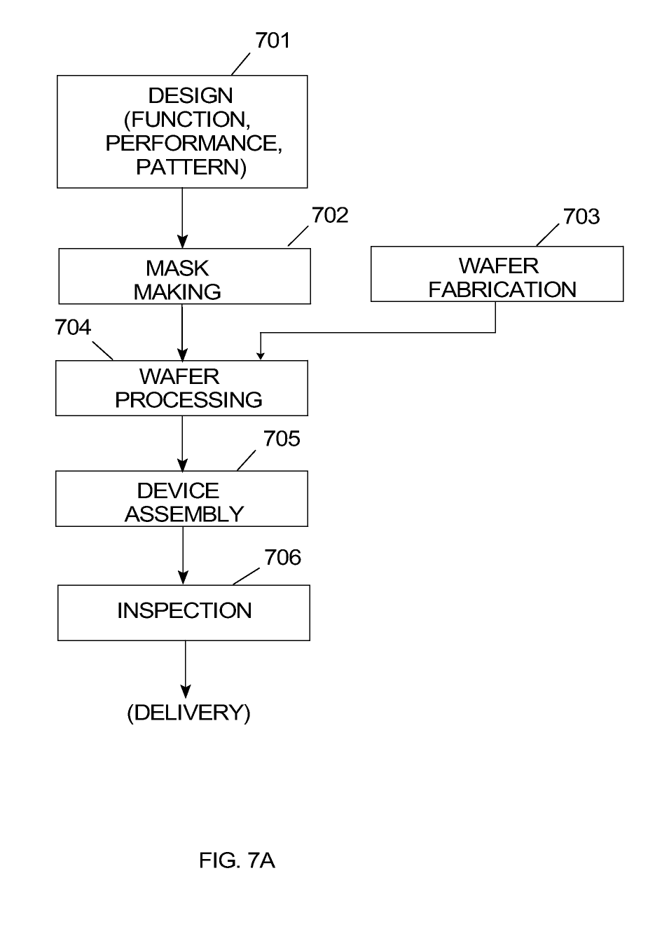

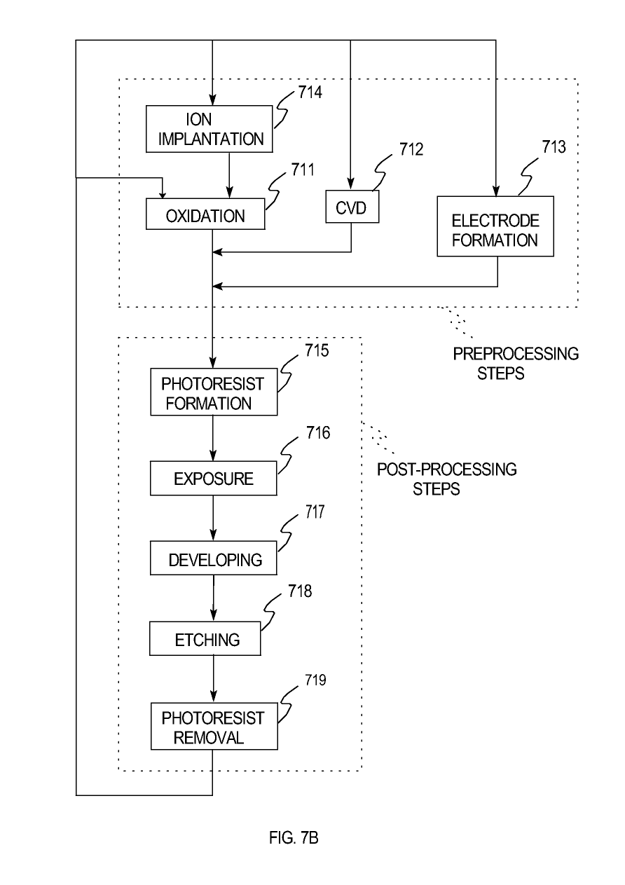

Semiconductor devices can be fabricated using the above described systems, by the process shown generally in FIG. 7A. In step 701 the device's function and performance characteristics are designed. Next, in step 702, a reticle (reticle) having a pattern is designed according to the previous designing step, and in a parallel step 703 a wafer is made from a silicon material. The reticle pattern designed in step 702 is exposed onto the wafer from step 703 in step 704 by a photolithography system described hereinabove in accordance with the present invention. In step 705, the semiconductor device is assembled (including the dicing process, bonding process and packaging process), finally, the device is then inspected in step 706.

FIG. 7B illustrates a detailed flowchart example of the above-mentioned step 704 in the case of fabricating semiconductor devices. In FIG. 7B, in step 711 (oxidation step), the wafer surface is oxidized. In step 712 (CVD step), an insulation film is formed on the wafer surface. In step 713 (electrode formation step), electrodes are formed on the wafer by vapor deposition. In step 714 (ion implantation step), ions are implanted in the wafer. The above mentioned steps 711-714 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 715 (photoresist formation step), photoresist is applied to a wafer. Next, in step 716 (exposure step), the above-mentioned exposure device is used to transfer the circuit pattern of a reticle (reticle) to a wafer. Then in step 717 (developing step), the exposed wafer is developed, and in step 718 (etching step), parts other than residual photoresist (exposed material surface) are removed by etching. In step 718 (photoresist removal step), unnecessary photoresist remaining after etching is removed. Multiple circuit patterns are formed by repetition of these preprocessing and post-processing steps.

It is to be understood that movers disclosed herein are merely illustrative of the presently preferred embodiments of the invention and that no limitations are intended to the details of construction or design herein shown other than as described in the appended claims.

What is claimed is:

1. A planar motor for positioning a stage along a first axis, and along a second axis that is perpendicular to the first axis, the planar motor comprising:
a conductor array that includes at least one conductor; and
a magnet array positioned near the conductor array and spaced apart from the conductor array along a third axis that is perpendicular to the first axis and the second axis, the magnet array including a first magnet unit having a first diagonal magnet with a diagonal magnetization direction that is diagonal to the first axis, the second axis and the third axis, the first diagonal magnet being generally wedge shaped.

2. The motor of claim 1 wherein one of the arrays is adapted to be secured to the stage, and wherein current directed to the conductor array generates a controllable force along the first axis and along the second axis.

3. The motor of claim 1 wherein the diagonal magnetization direction is at a magnetization angle that is approximately forty-five degrees relative to each axis.

4. The motor of claim 1 wherein the diagonal magnetization direction is at a magnetization angle that is approximately forty-five degrees relative to the first and second axes.

5. The motor of claim 1 wherein the first magnet unit further comprises a second diagonal magnet, a third diagonal magnet, and a fourth diagonal magnet that cooperate to provide a first combined magnetic flux that is somewhat aligned along the third axis in a first flux direction; wherein each diagonal magnet has a magnetization direction that is diagonal to the first axis, the second axis and the third axis, wherein each of the diagonal magnets is generally wedge shaped.

6. The motor of claim 5 wherein the diagonal magnets are arranged together in the shape of a rectangle.

7. The motor of claim 6 wherein the first magnet unit further comprises (i) a first transverse magnet that is positioned adjacent to the first diagonal magnet, (ii) a second transverse magnet that is positioned adjacent to the second diagonal magnet, (iii) a third transverse magnet that is positioned adjacent to the third diagonal magnet, and (iv) a fourth transverse magnet that is positioned adjacent to the fourth diagonal magnet; wherein each transverse magnet has a magnetization direction that is transverse to the third axis.

8. The motor of claim 7 wherein the first magnet unit further comprises (i) a fifth diagonal magnet that is positioned adjacent to the first transverse magnet, (ii) a sixth diagonal magnet that is positioned adjacent to the second transverse magnet, (iii) a seventh diagonal magnet that is positioned adjacent to the third transverse magnet, and (iv) an eighth diagonal magnet that is positioned adjacent to the fourth transverse magnet.

9. The motor of claim 8 further comprising a second magnet unit, a third magnet unit, and a fourth magnet unit, wherein the magnet units are organized adjacent to each other in a two dimensional array along the first axis and the second axis, and wherein the fifth diagonal magnet of the first magnet unit cooperates with adjacent magnet units to provide a second combined magnetic flux that is somewhat aligned along the third axis in a second flux direction that is opposite to the first flux direction.

10. The motor of claim 5 wherein the first magnet unit includes a pyramid shaped magnet.

11. The motor of claim 10 wherein the diagonal magnets are arranged together with the pyramid shaped magnet in the shape of a parallelepiped.

12. The motor of claim 1 wherein the conductor array includes a plurality of conductors, and wherein the control system independently directs current to each of the plurality of conductors.

13. A stage assembly that moves a device, the stage assembly including a stage that retains the device and the motor of claim 1 that is coupled to the stage.

14. An exposure apparatus including an illumination system and the stage assembly of claim 13 that moves the device relative to the illumination system.

15. A process for manufacturing a device that includes the steps of providing a substrate and forming an image to the substrate with the exposure apparatus of claim 14.

16. A method for positioning a stage along a first axis, and along a second axis that is perpendicular to the first axis, the method comprising the steps of:
coupling a planar motor to the stage, the planar motor comprising (i) a conductor array that includes at least one conductor, and (ii) a magnet array positioned near the conductor array and spaced apart from the conductor array along a third axis that is perpendicular to the first axis and the second axis, the magnet array including a first magnet unit having a first diagonal magnet with a diagonal magnetization direction that is diagonal to the first axis, the second axis and the third axis, the first diagonal magnet being generally wedge shaped; and
directing current to the conductor array to generate a controllable force along the first axis and along the second axis.

17. The method of claim 16 wherein the step of coupling includes the diagonal magnetization direction having a magnetization angle that is approximately forty-five degrees relative to each axis.

18. The method of claim 16 wherein the step of coupling includes the diagonal magnetization direction having a magnetization angle that is approximately forty-five degrees relative to the first and second axes.

19. The method of claim 16 wherein the step of coupling includes the first magnet unit further including a second diagonal magnet, a third diagonal magnet, and a fourth diagonal magnet that cooperate to provide a first combined magnetic flux that is somewhat aligned along the third axis in a first flux direction; wherein each diagonal magnet has a magnetization direction that is diagonal to the first axis, the second axis and the third axis, wherein each diagonal magnet is generally wedge shaped.

20. The method of claim 19 wherein the step of coupling includes arranging the diagonal magnets together in the shape of a parallelepiped.

21. The method of claim 19 wherein the step of coupling includes the first magnet unit further comprising transverse magnets positioned adjacent to the diagonal magnets; wherein each transverse magnet has a magnetization direction that is transverse to the third axis.

22. The method of claim 19 wherein the step of coupling includes the first magnet unit further comprising a fifth diagonal magnet.

23. The method of claim 22 wherein the step of coupling includes providing additional magnet units, and organizing the magnet units adjacent to each other in a two dimensional array along the first axis and the second axis, and wherein the fifth diagonal magnet of the first magnet unit cooperates with adjacent magnet units to provide a second combined magnetic flux that is somewhat aligned along the third axis in a second flux direction that is opposite to the first flux direction.

24. The method of claim 19 wherein the first magnet unit includes a pyramid shaped magnet.

25. The method of claim 24 wherein the diagonal magnets are arranged together with the pyramid shaped magnet in the shape of a parallelepiped.

26. A process for manufacturing a device that includes the steps of providing a substrate, coupling the substrate to the stage, positioning the stage by the method of claim 16, and forming an image on the substrate.
